(19) United States
(12) Patent Application Publication
(10) Pub. No.: US 2025/0062441 A1
(43) Pub. Date: Feb. 20, 2025

(54) BATTERY CELL INCLUDING A SELECTIVELY ACTIVATED FLUID INLET

(71) Applicant: GM Global Technology Operations LLC, Detroit, MI (US)

(72) Inventors: Ryan Patrick Hickey, Austin, TX (US); Chih-hung Yen, Bloomfield Hills, MI (US); Peter Paul Andruskiewicz, IV, Ann Arbor, MI (US); David R. Clark, Grosse Pointe Woods, MI (US); Matthew Swift, Atlanta, GA (US)

(21) Appl. No.: 18/451,311

(22) Filed: Aug. 17, 2023

(51) Int. Cl. H01M 10/6567; B60L 50/64; B60L 58/26; H01M 10/613; H01M 10/625; H01M 10/647; H01M 50/103; H01M 50/209; H01M 50/249; H01M 50/30

(52) U.S. Cl. CPC H01M 10/6567; B60L 50/64; B60L 58/26; H01M 10/613; H01M 10/625; H01M 10/647; H01M 50/103; H01M 50/209; H01M 50/249; H01M 50/30; H01M 2200/10; H01M 2200/20; H01M 2220/20

(57) ABSTRACT

A battery module includes a module housing including a plurality of walls defining an interior, an amount of fluid arranged in the interior, and a plurality of battery cells arranged in the interior and at least partially immersed in the amount of fluid. Each of the plurality of battery cells includes a cell can having an interior portion defined by a first wall member, a second wall member arranged opposite the first wall member, a first side wall member, and a second side wall member extending between and connected with the first wall member and the second wall member. The second wall member including a vent. An electrode stack is arranged in the interior portion. The cell can includes a thermally responsive fluid inlet that selectively exposes the interior portion of the cell can to the amount of fluid contained in the interior of the module housing.

### INTRODUCTION

The subject disclosure relates to the art of battery assemblies and, more particularly, to a battery cell including a selectively activated fluid inlet.

Rechargeable battery systems often include multiple connected battery cells arranged in a housing to form a battery module. Multiple battery modules are connected and arranged in a housing to form a battery assembly. The battery assembly may be used to provide motive power to, for example, a vehicle such as an automobile. In such an environment, the battery assembly is connected to a load, such as a drive motor, and a charge port that may be connected to a source of electric energy. The battery assembly discharges into the drive motor to provide power to the vehicle and is charged through the charge port.

When the battery assembly is cycled, that is going through periods of discharging into the load and being charged through the charge port, heat is generated in the battery cells. If a battery cell is discharged too deeply, or recharged improperly, the heat generated may be so great as to lead to a chemical reaction. The chemical reaction may ultimately cause a thermal runaway condition. Thermal runaway is a design consideration when producing batteries. Accordingly, it is desirable to provide a battery module with a system that limits heat spread through a battery assembly.

### SUMMARY

A battery module, in accordance with a non-limiting example, includes a module housing including a plurality of walls defining an interior, an amount of fluid arranged in the interior, and a plurality of battery cells arranged in the interior and at least partially immersed in the amount of fluid. Each of the plurality of battery cells includes a cell can having an interior portion defined by a first wall member, a second wall member arranged opposite the first wall member, a first side wall member, and a second side wall member extending between and connected with the first wall member and the second wall member. The second wall member includes a vent. An electrode stack is arranged in the interior portion. The cell can includes a thermally responsive fluid inlet arranged in one of the first wall member, the second wall member, the first side wall member, and the second side wall member. The thermally responsive fluid inlet selectively exposes the interior portion of the cell can to the amount of fluid contained in the interior of the module housing.

In addition to one or more of the features described herein the thermally responsive fluid inlet includes a thermally responsive hatch.

In addition to one or more of the features described herein an amount of thermally responsive adhesive bonds the thermally responsive hatch to the one of the first wall member, second wall member, first side wall member, and the second side wall member.

In addition to one or more of the features described herein a first hatch support is arranged adjacent the thermally responsive fluid inlet and a second hatch support is arranged opposite the first hatch support adjacent the thermally responsive fluid inlet.

In addition to one or more of the features described herein the thermally responsive hatch is supported between the first hatch support and the second hatch support.

In addition to one or more of the features described herein an amount of thermally responsive adhesive secures the thermally responsive hatch over the fluid inlet between the first hatch support and the second hatch support.

A vehicle, in accordance with a non-limiting example, includes a body including a passenger compartment, a drive motor mounted in the body, and a rechargeable energy storage system including a battery assembly mounted to the body. The battery assembly includes a battery module having a module housing including a plurality of walls defining an interior, an amount of fluid arranged in the interior, and a plurality of battery cells arranged in the interior and at least partially immersed in the amount of fluid. Each of the plurality of battery cells includes a cell can having an interior portion defined by a first wall member, a second wall member arranged opposite the first wall, a first side wall member, and a second side wall member extending between and connected with the first wall member and the second wall member. The second wall member includes a vent. An electrode stack is arranged in the interior portion. The cell can includes a thermally responsive fluid inlet arranged in one of the first wall member, the second wall member, the first side wall member, and the second side wall member. The thermally responsive fluid inlet selectively exposing the interior portion of the cell can to the amount of fluid contained in the interior of the module housing.

In addition to one or more of the features described herein the thermally responsive fluid inlet includes a thermally responsive hatch.

In addition to one or more of the features described herein an amount of thermally responsive adhesive bonds the thermally responsive hatch to the one of the first wall member, second wall, first side wall member, and the second side wall member.

In addition to one or more of the features described herein a first hatch support is arranged adjacent the thermally responsive fluid inlet and a second hatch support is arranged opposite the first hatch support adjacent the thermally responsive fluid inlet.

In addition to one or more of the features described herein the thermally responsive hatch is supported between the first hatch support and the second hatch support.

In addition to one or more of the features described herein an amount of thermally responsive adhesive secures the thermally responsive hatch over the fluid inlet between the first hatch support and the second hatch support.

A method of cooling a battery cell includes venting high temperature, high pressure gases from the battery cell through a vent, activating a thermally responsive fluid inlet with the high temperature high pressure gases, forcing the thermally responsive fluid inlet closed with the high temperature, high pressure gases after activating the thermally responsive inlet, opening the thermally responsive fluid inlet, and flooding the battery cell with fluid passing through the thermally responsive inlet.

In addition to one or more of the features described herein activating the thermally responsive fluid inlet includes heating a thermally responsive hatch with the high temperature, high pressure gases.

In addition to one or more of the features described herein heating the thermally responsive hatch includes degrading a thermally responsive adhesive bonding the thermally responsive hatch to a wall of the battery cell.

In addition to one or more of the features described herein forcing the thermally responsive inlet closed includes applying pressure to the thermally responsive hatch with the high temperature, high pressure gases.

In addition to one or more of the features described herein opening the thermally responsive inlet includes removing the pressure from the thermally responsive hatch.

In addition to one or more of the features described herein opening the thermally responsive inlet includes releasing the thermally responsive hatch.

In addition to one or more of the features described herein flooding the battery cells with fluid includes passing fluid from a battery module housing containing a plurality of battery cells into the battery cell venting high temperature, high pressure gases.

In addition to one or more of the features described herein venting the high temperature, high pressure gases through a vent includes passing the high temperature, high pressure gases through an opening in the battery cell spaced from an upper surface of the fluid in the battery module housing.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery assembly having battery cells including a thermally responsive fluid inlet, in accordance with a non-limiting example;

FIG. 2 is a view of a battery assembly having battery cells including a thermally responsive fluid inlet, in accordance with a non-limiting example;

FIG. 3 is a perspective view of a battery module housing battery cells including a thermally responsive fluid inlet, in accordance with a non-limiting example;

FIG. 4A is a perspective view of a battery cell including a thermally responsive fluid inlet, in accordance with a non-limiting example;

FIG. 4B is a cross-sectional view of the battery cell of FIG. 4A taken along the line 4B-4B, in accordance with a non-limiting example;

FIG. 5A is a cross-sectional view of the battery cell of FIG. 4A showing high temperature, high pressure gases developing within the battery cell, in accordance with a non-limiting example;

FIG. 5B is a cross-sectional view of the battery cell of FIG. 5A showing high temperature, high pressure gases activating the thermally responsive inlet, in accordance with a non-limiting example; and

FIG. 5C is a cross-sectional view of the battery cell of FIG. 5B showing fluid entering into the battery cell through the thermally responsive fluid inlet, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

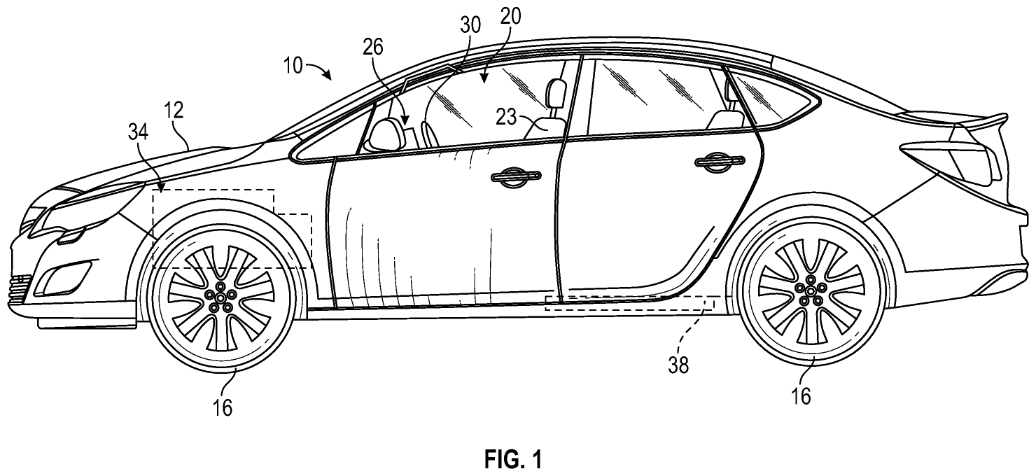

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electric drive motor 34 that provides power to one or more of the plurality of wheels 16.

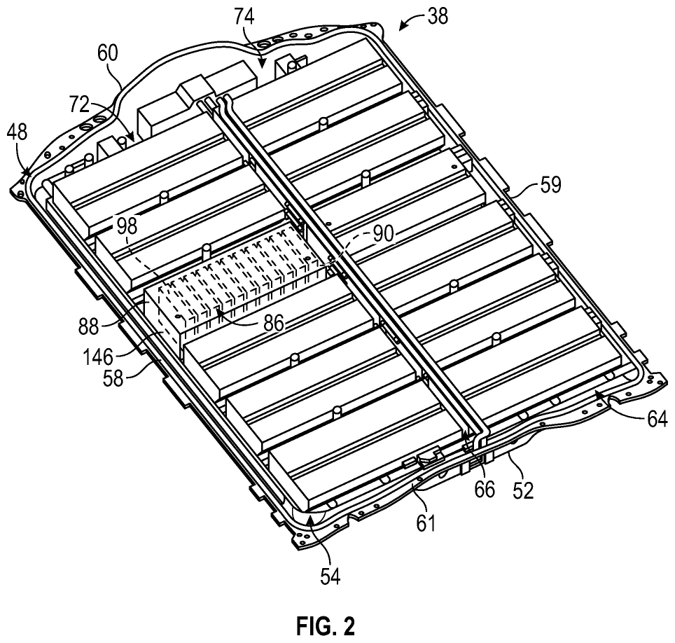

A rechargeable energy storage system (RESS) or battery assembly 38 is arranged in body 12 and provides power to electric drive motor 34. At this point, it should be understood that the location of electric drive motor 34 and battery assembly 38 may vary. Referring to FIG. 2, battery assembly 38 includes a housing 48 including a base wall 52 and a plurality of side walls 54. Side walls 54 include a first side wall 58, a second side wall 59, a third side wall 60, and a fourth side wall 61 that collectively define an interior zone 64. Housing 48 is shown to include a mid-line 66 in accordance with a non-limiting example. Mid-line 66 extends between third side wall 60 and fourth side wall 61 and is equally spaced from first side wall 58 and second side wall 59.

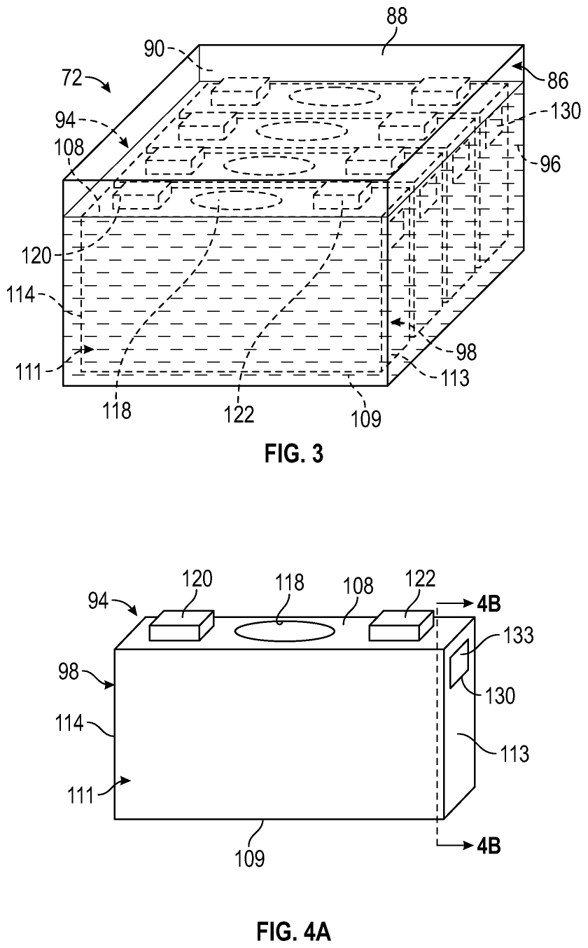

In a non-limiting example, a first plurality of battery modules 72 is arranged between mid-line 66 and first side wall 58 and a second plurality of battery modules 74 arranged between mid-line 66 and second side wall 59. Reference will now follow to FIG. 3 with continued reference to FIG. 2 in describing one of the first plurality of battery modules 72 with an understanding that remaining ones of the first plurality of battery modules 72 and the second plurality of battery modules 74 include corresponding structure.

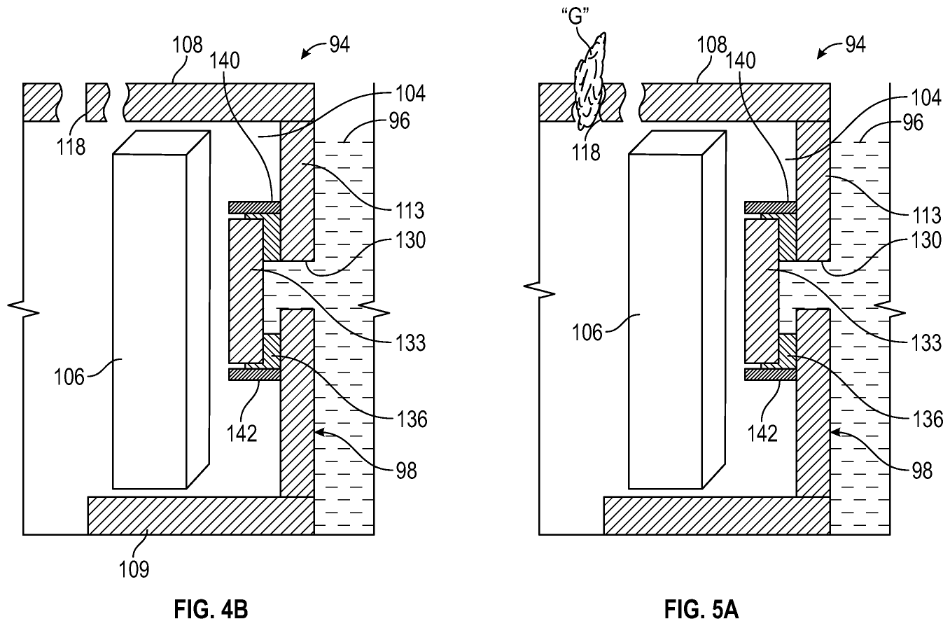

Referring to FIG. 3 battery module 72 includes a module housing 86 having a plurality of walls 88 that define an interior 90. In a non-limiting example, a plurality of battery cells 94 are arranged in interior 90. An amount of fluid 96 partially fills interior 90. Each of the plurality of battery cells 94 includes a cell can 98 having an interior portion 104, FIG. 4B, within which is arranged an electrode stack 106.

Cell can 98 is partially immersed in the amount of fluid 96 and, as shown in FIG. 4A, includes a first wall member 108, a second wall member 109, and a plurality of side wall members 111 that extend between and connect to first wall member 108 and second wall member 109. Plurality of side wall members 111 includes at least a first side wall member 113 and a second side wall member 114. In a non-limiting example, a vent 118 is formed in first wall member 108. First wall member 108 is further shown to support a first electrode 120 which may be an anode, and a second electrode 122 which may be a cathode. At this point, it should be understood that the location of vent 118, first electrode 120, and second electrode 122 may vary. Further, each of vent 118, first electrode 120, and second electrode 122 may be on the same wall member or different wall members.

In a non-limiting example, a thermally responsive fluid inlet 130 is formed in first side wall member 113 as shown in FIG. 4B. As will be detailed herein, thermally responsive fluid inlet 130 will open, following gas venting from interior portion 104, allowing a portion of the amount of fluid 96 to flood into and to cool electrode stack 106. In a non-limiting example, a thermally responsive hatch 133 is secured over thermally responsive fluid inlet 130 with an amount of thermally responsive adhesive 136. When exposed to a selected temperature, thermally responsive adhesive 136 degrades allowing thermally responsive hatch 133 to detach and open thermally responsive fluid inlet 130. Thermally responsive hatch 133 may be supported between a first hatch support 140 and a second hatch support 142 that project from an inner surface (not separately labeled) of first side wall member 113.

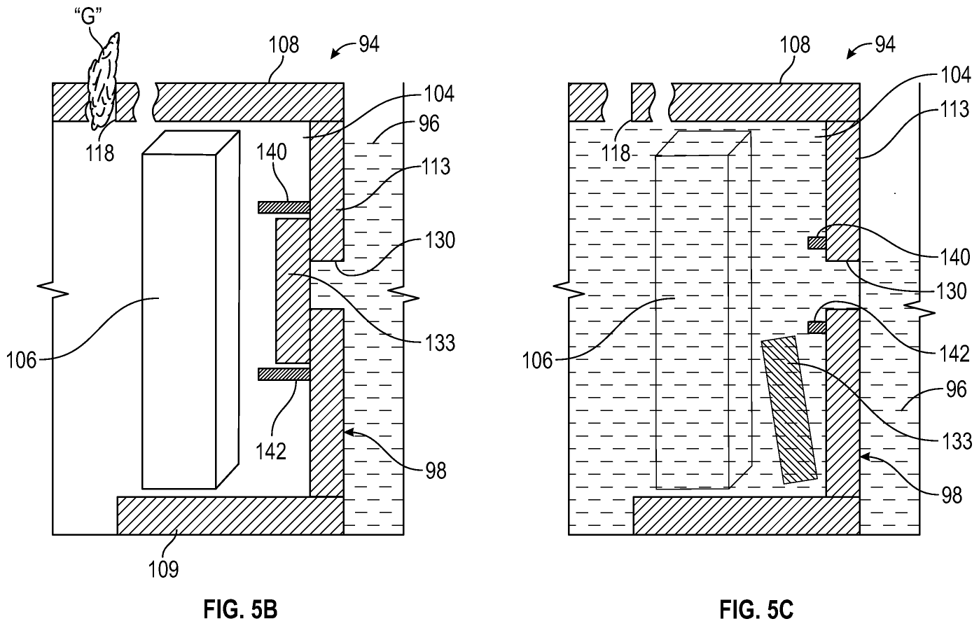

In a non-limiting example, one of the plurality of battery cells 94 may experience a fault that leads to an exothermic reaction creating high temperature, high pressure gases within interior portion 104. At this point, it should be understood that high temperature, high pressure gases are gases “G” that may have a temperature exceeding 1000° C. and a pressure that exceeds 150 kPa. The high temperature, high pressure gases “G” breach vent 118 and begin passing to ambient as shown in FIG. 5A. At the same time, the high temperature, high pressure gases “G” act on thermally responsive adhesive 136 releasing a bond holding thermally responsive hatch 133 over thermally responsive fluid inlet 130 as shown in FIG. 5B. While the bond may be gone, the high temperature high pressure gases “G” present in interior portion 104 continue to hold thermally responsive hatch 133 over thermally responsive fluid inlet 130.

As the high temperature, high pressure gases “G” pass through vent 118, pressure within interior portion 104 drops allowing thermally responsive hatch 133 to fall away from thermally responsive fluid inlet 130 as shown in FIG. 5C. In a non-limiting example, the temperature in interior portion 104 rises to a point that hatch supports 140 and 142 fail allowing thermally responsive hatch 133 to fall and expose thermally responsive fluid inlet 130. In another non-limiting example, once pressure within interior portion 104 drops, the amount of fluid 96 may simply force thermally responsive hatch 133 inwardly to open thermally responsive fluid inlet 130. In yet another non-limiting example, the high temperature, high pressure gases deform thermally responsive hatch 133 exposing thermally responsive opening 130 to the amount of fluid 96.

At this point, a portion of the amount of fluid 96 within module housing 86 floods into interior portion 104 through thermally responsive fluid inlet 130 in order to cool electrode stack 106. By rapidly cooling electrode stack 106 in cell can 98 the chance of a thermal runaway developing is significantly reduced.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery module comprising:
a module housing including a plurality of walls defining an interior;
an amount of fluid arranged in the interior;
a plurality of battery cells arranged in the interior and at least partially immersed in the amount of fluid, each of the plurality of battery cells including a cell can having an interior portion defined by a first wall member, a second wall member arranged opposite the first wall member, a first side wall member, and a second side wall member extending between and connected with the first wall member and the second wall member, the second wall member including a vent; and
an electrode stack arranged in the interior portion,
wherein the cell can includes a thermally responsive fluid inlet arranged in one of the first wall member, second wall member, first side wall member, and the second side wall member, the thermally responsive fluid inlet selectively exposing the interior portion of the cell can to the amount of fluid contained in the interior of the module housing.

2. The battery module according to claim 1, wherein the thermally responsive fluid inlet includes a thermally responsive hatch.

3. The battery module according to claim 2, further comprising an amount of thermally responsive adhesive bonding the thermally responsive hatch to the one of the first wall member, second wall member, first side wall member, and the second side wall member.

4. The battery module according to claim 2, further comprising a first hatch support arranged adjacent the thermally responsive fluid inlet and a second hatch support arranged opposite the first hatch support adjacent the thermally responsive fluid inlet.

5. The battery module according to claim 4, wherein the thermally responsive hatch is supported between the first hatch support and the second hatch support.

6. The battery module according to claim 5, further comprising an amount of thermally responsive adhesive securing the thermally responsive hatch over the thermally responsive fluid inlet between the first hatch support and the second hatch support.

7. A vehicle comprising:
a body including a passenger compartment;
a drive motor mounted in the body; and
a rechargeable energy storage system including a battery assembly mounted to the body, the battery assembly comprising:
a battery module comprising:
a module housing including a plurality of walls defining an interior;
an amount of fluid arranged in the interior;
a plurality of battery cells arranged in the interior and at least partially immersed in the amount of fluid, each of the plurality of battery cells including a cell can having an interior portion defined by a first wall member, a second wall member arranged opposite the first wall member, a first side wall member, and a second side wall member extending between and connected with the first wall member and the second wall member, the second wall member including a vent; and
an electrode stack arranged in the interior portion,
wherein the cell can includes a thermally responsive fluid inlet arranged in one of the first wall member, second wall member, first side wall member, and the second side wall member, the thermally responsive fluid inlet selectively exposing the interior portion of the cell can to the amount of fluid contained in the interior of the module housing.

8. The vehicle according to claim 7, wherein the thermally responsive fluid inlet includes a thermally responsive hatch.

9. The vehicle according to claim 8, further comprising an amount of thermally responsive adhesive bonding the thermally responsive hatch to the one of the first wall member, second wall, first side wall member, and the second side wall member.

10. The vehicle according to claim 8, further comprising a first hatch support arranged adjacent the thermally responsive fluid inlet and a second hatch support arranged opposite the first hatch support adjacent the thermally responsive fluid inlet.

11. The vehicle according to claim 10, wherein the thermally responsive hatch is supported between the first hatch support and the second hatch support.

12. The vehicle according to claim 11, further comprising an amount of thermally responsive adhesive securing the thermally responsive hatch over the fluid inlet between the first hatch support and the second hatch support.

13. A method of cooling a battery cell, the method comprising:
venting high temperature, high pressure gases from the battery cell through a vent;
activating a thermally responsive fluid inlet with the high temperature, high pressure gases;
forcing the thermally responsive fluid inlet closed with the high temperature, high pressure gases after activating the thermally responsive fluid inlet;
opening the thermally responsive fluid inlet; and
flooding the battery cell with fluid passing through the thermally responsive fluid inlet.

14. The method of claim 13, wherein activating the thermally responsive fluid inlet includes heating a thermally responsive hatch with the high temperature, high pressure gases.

15. The method of claim 13, wherein heating the thermally responsive hatch includes degrading a thermally responsive adhesive bonding the thermally responsive hatch to a wall of the battery cell.

16. The method of claim 14, wherein forcing the thermally responsive fluid inlet closed includes applying pressure to the thermally responsive hatch with the high temperature, high pressure gases.

17. The method of claim 16, wherein opening the thermally responsive fluid inlet includes removing the pressure from the thermally responsive hatch.

18. The method of claim 16, wherein opening the thermally responsive fluid inlet includes releasing the thermally responsive hatch.

19. The method of claim 13, wherein flooding the battery cell with fluid includes passing fluid from a battery module housing containing a plurality of battery cells into the battery cell venting high temperature, high pressure gases.

20. The method of claim 19, wherein venting the high temperature, high pressure gases through a vent includes passing the high temperature, high pressure gases through an opening in the battery cell spaced from an upper surface of the fluid in the battery module housing.
